(19) United States
(12) Patent Application Publication
(10) Pub. No.: US 2020/0102712 A1
(43) Pub. Date: Apr. 2, 2020

(54) CONTAMINATION REMOVAL SYSTEM

(71) Applicant: William Matthew Caldwell, Ocean Springs, MS (US)

(72) Inventor: William Matthew Caldwell, Ocean Springs, MS (US)

(21) Appl. No.: 16/149,885

(22) Filed: Oct. 2, 2018

(51) Int. Cl. E02B 15/04; C02F 1/00; C02F 1/26; E02B 15/10

(52) U.S. Cl. CPC E02B 15/048; C02F 1/004; E02B 15/046; E02B 15/104; C02F 1/26

(57) ABSTRACT

A fluid contaminate removal system having a module with an elongated body having frame extending from a first end to a second end; a first roller secured to the first end of the frame; a second roller secured to the second end of the frame; a belt secured to the first roller and the second roller, the belt having a plurality of wiper integral with and protruding from the belt, the belt is configured to rotate around both the first roller and the second roller; a lower shroud secured to the frame; a compartment formed between the belt and the lower shroud; a first opening formed by the lower shroud and the first end of the frame; a second opening formed by the lower shroud and the second end of the frame.

### BACKGROUND

### 1. Field of the Invention

The present invention relates generally to petroleum collection systems, and more specifically, to methods and devices for removing petroleum and debris floating in water or any other fluid. It should also be understood that the features discussed herein could be incorporated in removing any type of contaminates from a fluid body in alternative embodiments.

### 2. Description of Related Art

Petroleum collection systems are well known in the art and are effective means to gather, group or relocate fossil fuels wherever they are found. For example, FIG. 1 depicts a conventional surface skim system 101 having scoops 107 attached to a belt 109 tensioned by wheels 103 and 105. During use, the wheels 103 and 105 cause the belt 109 and the scoops 107 to rotate and collect petroleum generally in a body of water.

One of the problems commonly associated with system 101 is its limited use. For example, flotsam and other debris floating in the water mix with the petroleum and prevent the scoops 107 or belt 109 from collecting the petroleum.

Accordingly, although great strides have been made in the area of surface skim systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a prospective view of a common surface skim system;

FIG. 2 is a side view of a contamination removal system in accordance with a preferred embodiment of the present application;

FIG. 3 is a top view of the system of FIG. 2;

FIG. 4 is a side view of an alternative use of the system of FIG. 2;

FIG. 5 is a side view of an alternative embodiment of the system of FIG. 2;

FIG. 6 is a side view of another alternative embodiment of the system of FIG. 2; and

FIG. 7 is a top view of the embodiment of FIG. 6.

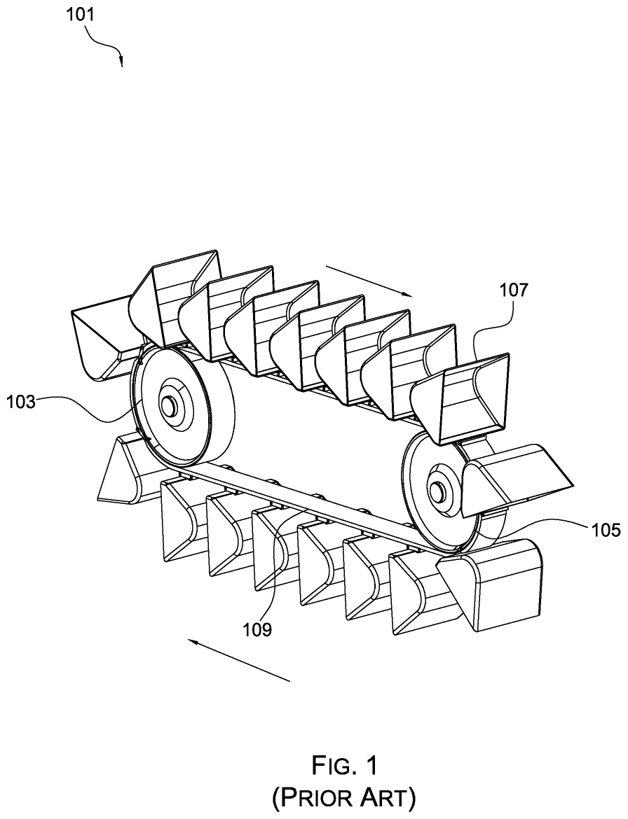

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional surface skim systems. Specifically, the invention of the present application enables the collections and removal of contaminants, particularly petroleum products, mixed with debris from a fluid body such as a river, lake, sea or ocean. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

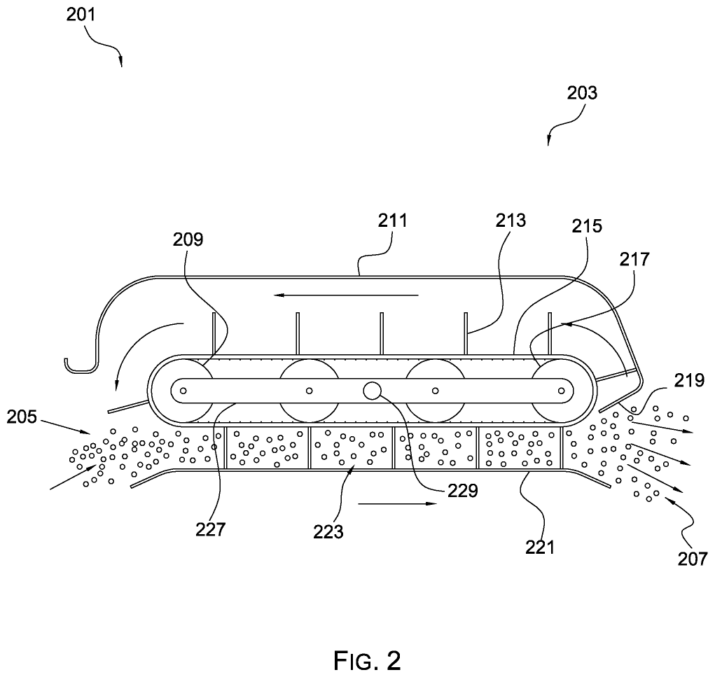

Referring now to the drawings wherein like reference characters identify corresponding or similar elements throughout the several views, FIG. 2 depicts a side view of a contamination removal system in accordance with a preferred embodiment of the present application. It will be appreciated that system 201 overcomes one or more of the above-listed problems commonly associated with conventional surface skim systems.

In the contemplated embodiment, system 201 includes a module 203 that forces contaminants 205 into compartments 223 formed between wipers 213, belt 215 and a lower shroud 221. The belt 215 is attached to a main frame 227 via a first roller 209 and a second a roller 217. The main frame 227 is able to pivot around point 229 to adjust the intake an exit of the contaminants 205. The system also includes an upper shroud 211 that has a flange 219 at the exit 207 thereof.

In use the system 201 is lowered to the surface or just below a body of fluid. The first roller 209 and second roller 217 cause the belt 215 to rotate along with the wipers 213 forcing or containing contaminants 205 in the compartments 223 where they are transported to the exit 207 for disposal.

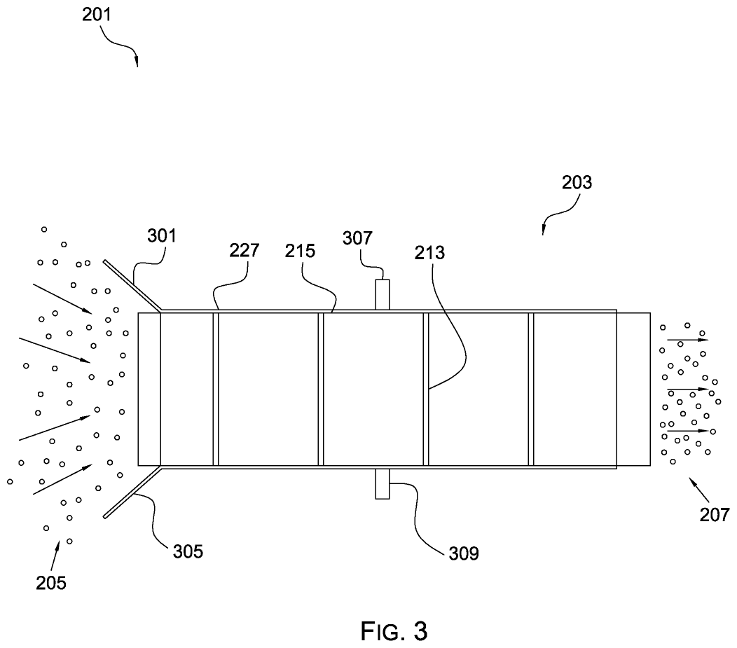

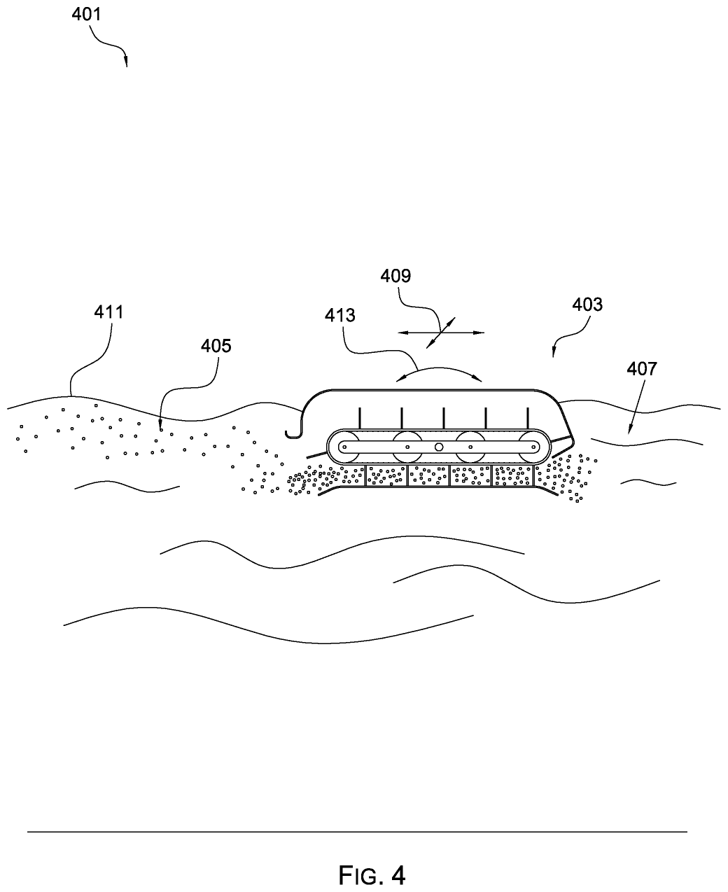

Referring now to FIG. 3 it is contemplated that contaminants 205 of a wide area are directed to the inlet of the system via guides 301 and 305 secured to the main frame 227. It is further depicted that the module 203 rotates about shafts 307 and 309 secured to frame 227 and configured to selectively adjust the angel of the system to the contaminants 205.

It should be appreciated that one of the unique features believed characteristic of the present application is that the wipers 213 and the compartments 223 formed thereby enables the removal of contaminants 205 for a fluid body by facilitating their collection.

An alternative use of the system 201, in this embodiment 401 a module 403 collects contaminants 405 for a fluid body 411 and relocates them to a different area 407 or depth of the fluid body 411. It is contemplated that the module 403 could rotate 413 or translate 409 so that any direction or attitude may be assumed thereby.

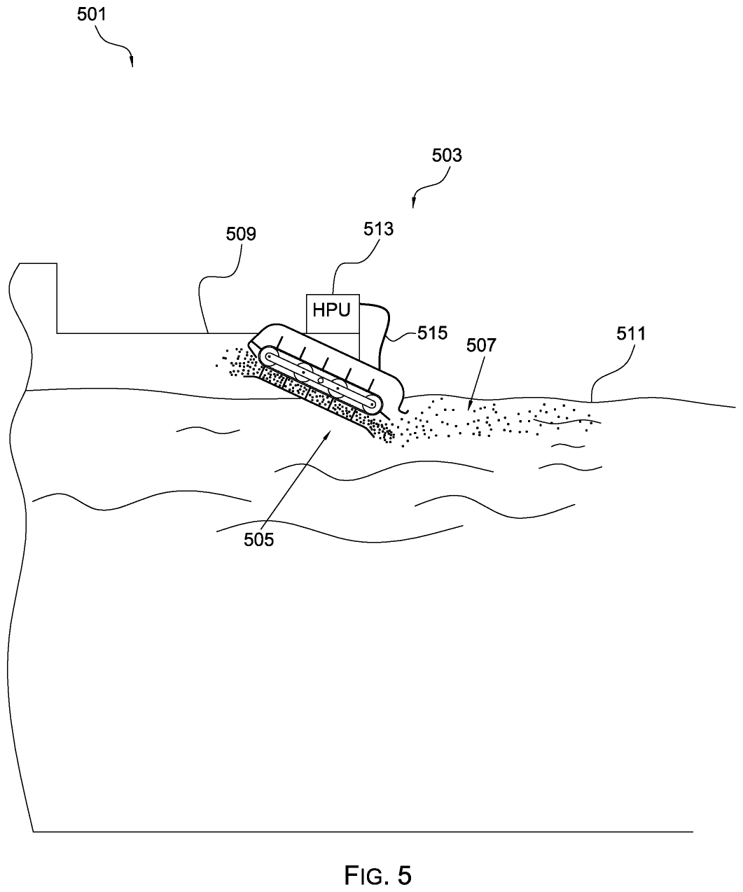

Referring now to FIG. 5 an alternative embodiment of system 201 is depicted. Embodiment 501 including a module 503 attached to a vessel 509 and that is positioned by a hydraulic power unit (HPU) 517 and the requisite lines 515. Contaminants 507 are collected and removed from body of water 511 via the compartments 505. The contaminants are transferred to the vessel 509 for storage.

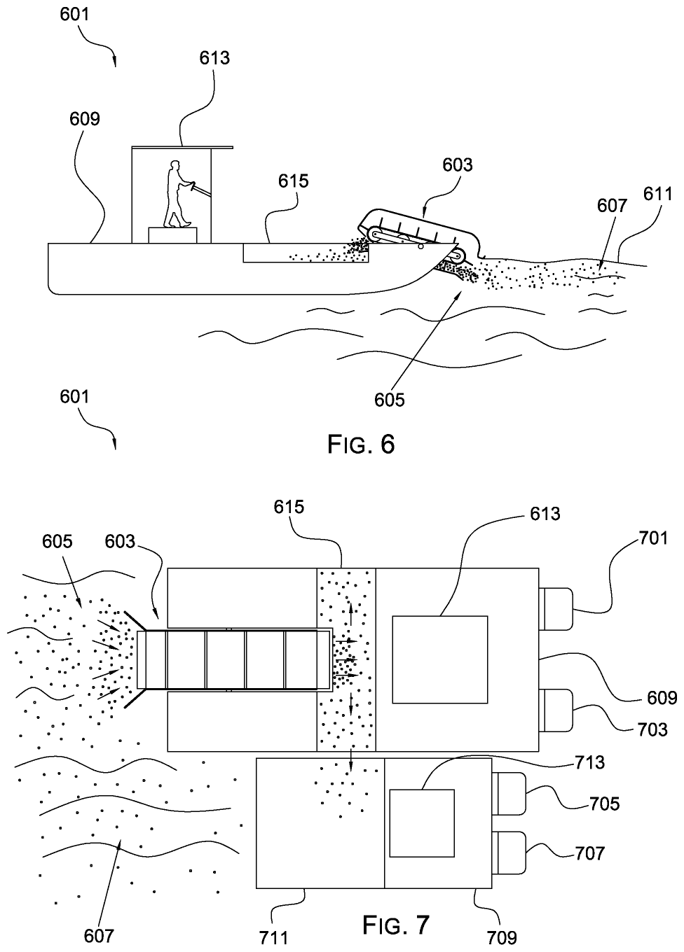

Referring now to FIGS. 6 and 7 an additional alternative embodiment of system 201 is depicted. Embodiment 601 including a module 603 attached to a first vessel 609 operated by a control center 613 and having a storage area 615. The module 603 gathers and removes contaminates 605 but has not collected the remaining contaminants 607 from the body of water 611. It will be understood that the quantity of contaminants 605 and 607 could exceed the amount able to be removed by a single module 603 at one time. It will further be understood that storage area 615 will have a finite volume and that this limits the ability of the module 603 with the first vessel 609 to remove contaminants 605 and 607.

It will now be appreciated that a second vessel 709 with its respective control center 713 and storage area 711 is positioned in proximity to the first vessel 607 to transfer the collected contaminants 605 so that the first vessel 609 with its module 603 has capacity to remove the remaining contaminants 607 for the body of water 611.

It is contemplated that for the first vessel 609 to be positioned in proximity to the second vessel 711 that each vessel will need positioning motors 701 and 703 for the first vessel and 705 and 707 for the second vessel 709. It will be understood that while these positioning motors 701, 703, 705, 707 are depicted at the rear of the first vessel 609 and second vessel 709 that they are could be attached at other points and are configured to keep the vessels in proximity.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A fluid contaminate removal system for removing fluid containments, comprising:
a vessel having:
a vessel body; and
a hydraulic system;
a module having:
an elongated module body having a module frame extending from a first end to a second end;
a first roller secured to the first end of the module frame;
a second roller secured to the second end of the module frame;
a belt secured to the first roller and the second roller, the belt having a belt frame;
a shaft extending from the belt frame, the shaft is rotatably attached to the vessel body;
wherein the hydraulic system is configured to pivot the module body about the shaft;
plurality of wiper integral with and protruding from the belt, the belt is configured to rotate around both the first roller and the second roller;
a lower shroud secured to the module frame;
a compartment formed between the belt and the lower shroud;
a first opening formed by the lower shroud and the first end of the module frame;
a second opening formed by the lower shroud and the second end of the module frame:
wherein the plurality of wipers pass through the compartment; and
wherein fluid contaminants are channeled through the compartment and driven via the plurality of wipers.

2. The system of claim 1, further comprising:
a plurality of guides extending at an angle relative to an integral with the frame.

3. (canceled)

4. (canceled)

5. The system of claim 1, the vessel, comprising:
a storage compartment for storage of contaminants passing through the compartment.

6. The system of claim 5, further comprising:
a second boat having a second storage area;
wherein contaminant from the boat is transferred to the second boat.

7. A fluid contaminate removal system, comprising:
a boat with a storage containment areas, the boat having:
a body extending from a front area to a back area;
a containment reservoir;
an adjustable module secured to the front area of the body, the adjustable module, having:
an elongated body having frame extending from a first end to a second end;
a first roller secured to the first end of the frame;
a second roller secured to the second end of the frame;
a belt secured to the first roller and the second roller, the belt having a belt frame;
a shaft extending from the belt frame, the shaft is rotatably attached to the vessel body;
wherein the hydraulic system is configured to pivot the module body about the shaft:
plurality of wiper integral with and protruding from the belt, the belt is configured to rotate around both the first roller and the second roller;
a lower shroud secured to the frame;
a compartment formed between the belt and the lower shroud;
a first opening formed by the lower shroud and the first end of the frame;
a second opening formed by the lower shroud and the second end of the
wherein the plurality of wipers pass through the compartment;
wherein fluid contaminants are channeled through the compartment and driven via the plurality of wipers; and
wherein fluid contaminants are directed to the containment reservoir.

8. The system of claim 7, the adjustable module, further comprising:
a plurality of guides extending at an angle relative to an integral with the frame.

9. (canceled)

10. The system of claim 7, further comprising:
a second boat having a second storage area;
wherein contaminant from the boat is transferred to the second boat.
